(19) United States
(12) Patent Application Publication
(10) Pub. No.: US 2009/0129594 A1
(43) Pub. Date: May 21, 2009

(54) System and method for providing a trusted network facilitating inter-process communications via an e-box

(76) Inventors: Clark Weissman, Tarzana, CA (US); Brant Devlin Hashii, Long Beach, CA (US); Dwight Edgar Cass, Culver City, CA (US); Jeffrey Alan Barnett, Culver City, CA (US); Gerald Duane Cole, Los Angeles, CA (US)

Correspondence Address: BRUCE B. BRUNDA;STETINA BRUNDA GARRED 7 BRUCKER, 75 ENTERPRISE, SUITE 250, ALISO VIEJO, CA, 92656, US

(21) Appl. No.: 11/986,406

(22) Filed: Nov. 21, 2007

(51) Int. Cl. H04K 1/00; H04L 9/00

(52) U.S. Cl. 380/255; 380/278

(57) ABSTRACT

A system and methods for providing a trusted network which facilitates inter-process communication in accordance with an aspect of the present invention. The system includes processes, a security device, a network security element, a communication path and an outside server. A method for enabling inter-process communication commences when one processes initiates communication with another process. A security device encrypts the message and validates it if the communication is in accordance with the network's security policy via the network security element. The security device functions to directly permit or cancel any communication between processes on the network. The initialization of the security device upon the network results in a series of interactions between the security device and the network security element. Such an initialization identifies the security device as being operational upon the network and further provides the security device with essential parameters of the network, including the location of the processes and the network security element.

### CROSS-REFERENCE TO RELATED APPLICATIONS

Not Applicable

### STATEMENT RE: FEDERALLY SPONSORED RESEARCH/DEVELOPMENT

Aspects of the following invention have being funded by DARPA. There are current initiatives to procure additional funding.

### BACKGROUND

1. Field of Invention

The present invention relates to a system and methods facilitating trusted inter-process communication on a multilevel secure system, more specifically, to a uniquely configured network, with an architecture capable of utilizing a security device to enable data encryption on the process level.

2. Related Art

According to the Department of Defense (Hereafter “DoD”), future military projects envision a completely interconnected battle space between nations and international partners. A vital component of an interconnected battle space, between a multitude of partners, calls for effective data-information sharing between parties. Additionally, such parties should be able to communicate efficiently. However, the sensitive nature of military information requires the use of security classification levels to categorize data. As a result, it is important to make pertinent data accessible to appropriate parties. However, it is even more important to keep particular data inaccessible to other parties.

Currently, most aviation-related military data is unclassified, with a small percentage identified as “Secret” or “Top Secret.” Usually, aircrafts are classified as “System-High,” which represents the highest level of data in the system. As a result, an entire plane can be classified as “Top Secret,” even if the aircraft only has one “Top Secret” data element.

Furthermore, in a typical DoD network application, a single security level of operation may require a net. As a result, it is common in defense installations to have four individual, separate networks to protect Unclassified, Secret, Top secret, and Top Secret/Special Access Required classification, with an “air gap” between them to prevent electrical interconnect. The air gaps prevent security violations and unintended data leaks.

However, System-High and separate networks will not be effective protection in the future world of integrated battlefield flexibility. Weapon systems and sensors will have different security sensitivities, and people will create multiple secure data streams. These will need to be managed in a Multilevel Security (MLS) manner to allow battlefield flexibility, and so that information is not over-classified as System-High. It is unrealistic and ineffective to clear all battlefield personnel to System High. This includes multiple compartments serving friendly forces, uncleared foreign partners, as well as humanitarian personnel.

Particularly in the field of avionics, information with varying levels of security are processed by different applications. In this regard, there must be trust that classified information will not be leaked between processes. However, it is expensive and complex to design and to develop trusted software. As a result, most avionics systems default to operate at System-High, the highest classification level. However, such static classification methods inhibit the functionality of a versatile system, resulting in particular processes and applications unnecessarily becoming inaccessible. As such, this limitation would considerably strain the desire and purpose of having a robust communications network where diverse parties may effectively share information.

Unfortunately, few commercial solutions are strong enough to guarantee the high assurance MLS requirements for these systems. The traditional approach is to scratch build a high assurance trusted MLS system or a trusted operating system. However, these alternatives are unattractive because 1) the avionics requirements are quite broad to meet all of the needs of future battle space, 2) obtaining certification and accreditation from the DoD is a lengthy process that may not be completed by the time of need, 3) systems may not satisfy real-time avionics needs, and 4) such traditional approaches are very expensive.

Furthermore, any viable possibility to employ a secure information network for military use must be compliant with the DoD's certification and accreditation, such as the DoD's Trusted Computer Security Evaluation Criteria (TCSEC) or its replacement “Common Criteria”. The NSA and the Air Force have supported Common Criteria to include protection kernels that divide processors into isolated domains with controller inter-domain communication. This allows each partition to run on a different security-level. As of now, the BLACKER, Gemini Computer's GEMSOS, and the Boeing's MLS LAN, are the only systems certified under the TCSEC at the highest level, A1. However, no Common Criteria evaluations of these systems have been made.

In this regard, there is a current need in the art for a high assurance multilevel security system employing an infrastructure supporting multi-processor distributed applications. Furthermore, there is a need in the art for a system and methods enabling processes to be assigned classification security levels rather than whole applications, and said processes being able to communicate via trusted inter-process communication. Additionally, there is a need in the art for a system where a security device may permit separate applications and processes, employing various security level classifications, to be electrically interconnected into a single shared secure network, while still retaining the requisite safeguards to allow only intended and authorized communications. Furthermore there is a need in the art to develop a multi level system that is reliable, low cost, and not susceptible to virus attacks. Moreover, such a system must be compliant with the threshold certification and accreditation requirements of the DoD's Common Criteria.

### BRIEF SUMMARY

In order to address many of the above-mentioned drawbacks associated with the prior art, a multi-level secure network facilitating trusted inter-process communication is provided. The means taught herein may be used in avionics systems; however the general architecture of the present invention has a robust functionality that may be employed in a variety of systems.

It is a primary aspect of the present invention to provide a system wherein a network facilitates trusted inter-process communication. It is another aspect of the present invention where encryption and security classification is employed on the process level, thus creating trusted application connections with unique trusted cryptographic elements. It is another aspect of the present invention to provide a system having a network architecture wherein the operative components are security device or “e-box”, which is interposed between an Avionics Application Process (AAP) and the communication channel. Additionally, it is another aspect of the present invention to provide a Network Security Element (NSE) to control the inter-process communication via distribution of encryption and authentication keys to the e-boxes.

According to an exemplary embodiment of the present invention, an AAP represents a process in an avionics system. However, the architecture of the present system is not limited to cater only to avionic processes, but to non-avionic processes as well. For example, opening a document in Microsoft Word or referencing the Internet on Microsoft Internet Explorer may likely be representative processes.

According to another exemplary embodiment of the present invention, each AAP may be designated a security level and may be assigned to run on one processor. The conceptual design of the present invention enables the system to be low cost. The design is predicated on the theory set forth by Moore's Law that the number of processors will increase exponentially over time as the cost of processors correspondingly decrease. Currently, avionics systems have hundreds of processors running a number of different functions including navigation, targeting, sensors, and communications. Predictably, avionics systems of the future will be running thousands of processors. In this regard, the architecture of the present invention, whereby assigning one process to one processor, is resultantly cost effective.

However, it will be appreciated that the architecture of the present system is not limited to a one to one ratio between processes and processors. The necessary relationship between the ratio of processes to processors may vary according to design parameters and performance efficiency, among other factors. For example, a particular application comprising of several processes, all classified at the same security level, may conveniently be running on one processor. Such an assignment is predicated upon design requirements and is function specific.

According to another exemplary embodiment of the present invention, each processor may be front-ended with an e-box. Additionally, there may be hundreds or even thousands of AAP/e-box pairs on a network. Consequently, the e-box controls all communications coming in and out of an AAP. In this regard, an e-box may conduct two distinctive functional side operations. One functional side operation of an e-box may perform functions on sensitive clear text and manages encryption hardware with trusted code, and wherein another side performs functions on untrusted processes that work with the network messaging of cipher text. Consequentially, an e-box may be designed to act in a transparent capacity. As such, an AAP, application, or user is unaware of the e-boxes presence upon the network. Additionally, outside processes, applications, or users sharing the communication network will be unaware of an e-boxes presence.

An AAP may communicate with other AAPs, however, permission is granted based upon their respective security levels. Security levels may be set in accordance with the network's security policy as dictated by an outside server. The security policy is loaded and stored within the NSE and subsequently assigned via the NSE to the network's e-boxes.

Accordingly, permissions are granted, subject to validation, via the NSE. The e-box is the only access between the AAP and the communications network and functions as a gateway to ensure that messages can be sent only to authorized recipients and that all messages are encrypted. In this regard, the NSE may employ public key infrastructure (PKI) as an encryption protocol, of which the NSE's public key is embodied within an e-box.

According to another exemplary embodiment of the present invention, the system provides encryption of all communication on the process level. Additionally, all communication from an AAP is encrypted by its corresponding e-box. The advantageous feature of such a design enables different AAPs within the same application being encrypted in accordance to their designated security level. Therefore, if one component of an application is classified “Top Secret” and another is classified “Unclassified”, it is unnecessary to render the entire application “Top Secret”. Additionally, all communication between an e-box and the NSE is encrypted. The NSE stores binding assignments for e-boxes and AAPs. In this regard, the NSE provides specific encryption keys to each e-box/AAP pair customized to their respective security classification.

According to another embodiment of the present invention, the architecture of the system may be unsusceptible to hostile attacks. Currently, there is a primary threat for such systems to be susceptible to virus attacks, such as a Trojan Horse virus. A Trojan Horse virus may infect a system and run on any of the processors and attempt to leak data, either singly or collectively. The advantageous design of the present invention provides for a network with an architecture in which an attacker cannot inject messages into the network without going through an e-box. Although an e-box may regulate all communications coming in and out of an AAP, an attacker may still be able to eavesdrop. In order to avert potential eavesdroppers, the present invention divides each application into distinct functions, whereby each function is operating on a single security level on a single processor.

According to another embodiment of the present invention, an e-box may be a hardware component. In an exemplary embodiment wherein an e-box is a hardware component, the e-box may contain an internal central processing unit with local RAM memory, a local bus with memory space, a cryptographic ignition key, a protocol stack, I/O ports, and smart trusted software that performs the e-box network crypto-connections functions and routing. The software is designed in accordance with Common Criteria EAL7 to protect classified information. The crypto ignition key provides customization of the initialization parameters for the e-box's security level. The encryption keys are able to encrypt and decrypt messages coming in and out of the e-box. The e-box may physically sit between an AAP and the network router/switch, from which it takes its power. However, the conceptual design of an e-box is not limited to only being characterized as hardware. The security features provided by an e-box may very likely be implicated in a software version as well.

According to another embodiment of the present invention, an e-box may be wired or wireless, and stationary or mobile. An embodiment of the present invention provides an e-box equipped to provide an unforgeable source identification and authentication. Additionally, an e-box may advantageously provide end-to-end confidentiality protection, avoiding the current problems with VPNs, which leave information unprotected on the VPN Server access links. An e-box may also provide cryptographic strength data integrity and proof of delivery of communications sent. It is contemplated that an e-box may also utilize an audit server to record, who talked to whom, and when. Furthermore, due to the sensitive nature of data and information passing through a network, at any given time, and the necessity to thwart espionage or unintended data leaks, an e-box may be attack resistant and provide spoof countermeasures. Additionally, an e-box taking on a hardware form may likely be equipped with tamper resistant casing in order to provide extra security.

According to another embodiment of the present invention, a method is provided to facilitate trusted inter-process communication. The method may begin by one AAP initiating communication with another AAP by transmitting a communication message. The method may continue with an e-box authenticating whether an open connection preexists between the AAPs. An open connection may exist if the AAPs had prior communication with one another. If an open connection does not exist, the method may continue by the NSE validating the open request to ascertain if such connection is permissible. The permissibility of such a request is based upon designated security clearances of the AAPs. The method may continue by the NSE generating a session key permitting the AAPs to communicate and subsequently sending the session key to the corresponding e-boxes bound to the AAPs. The session keys instruct the e-boxes that the intended communication between the AAPs is authorized. The method may continue by generating an acknowledgement message within the e-box upon receiving the session key and transmitting the acknowledgement message back to the NSE. The method may continue by the NSE sending a synchronization message from the NSE to the e-box, instructing the e-box to start using the key.

According to another embodiment of the present invention, a method is provided of initializing an e-box. The method may begin by the NSE loading assignment parameters of e-box/AAP pairs. Such parameters may be loaded into the NSE through an outside server, whose only direct connection to the network is through the NSE. In an exemplary embodiment of the present invention being utilized in a military context, the NSE may be programmed by mission control. The method may continue by generating a random key and authentication message within the e-box and subsequently sending the random key, authentication message, net address, and integrity checksum from the e-box to the NSE. Upon receipt, the NSE subsequently creates a session key between the e-box and the NSE. The method may continue by thereafter assigning the correlating AAP to the e-box and assigning an identity to the e-box as affiliated with that AAP. The method may continue by the e-box sending a synchronization message to the NSE.

According to another embodiment of the present invention, security mechanisms are provided ensuring that all communications throughout the network are safeguarded. As a result, it is vital to design and deploy a system capable of being protected against known and unknown hazards. In this regard, the system must be capable of safeguarding against a known safety issues, specifically when an AAP changes security level classification while in the midst of communication. The present system may employ numerous measures to combat sporadic AAP security level classification changes. Namely, the associated e-box bound to the AAP may simply power down. The advantage of the e-box powering down, when a security level change is detected, is that its memory will be flushed, thereby clearing any old session keys. In this regard, if an e-box were to be compromised by hostile parties, there would be no record of any session keys implicating a correlation between an e-box and the AAPs or the NSE. Consequently, all connections previously established by that specific AAP would be lost.

Similarly, if an AAP were to malfunction or unexpectedly lose power, the corresponding e-box would resultantly power down. As a result, no messages intended for or transmitted from that AAP would be decrypted within the e-box. Once the AAP regains its appropriate classification, or regains power, the e-box may simply re-establish its connections. As a result, the e-box shall re-initialize itself and reestablish connections with the NSE and its corresponding AAP. Upon which the NSE will then send a new set of encryption keys for each previously opened connection involving that AAP.

In accordance with these and other objectives, the secure architecture of the present invention is having a commercial name MLS-PCA. Although the system of the present invention has not yet completed its evaluation by the DoD, it is designed to satisfy the certification and accreditation requirements of Common Criteria.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a block diagram illustrating the high level topography of an environment in which one aspect of the present invention may be implemented, including various interconnected AAPs, e-boxes, the NSE, an outside server, and a communication path;

FIG. 2 is a block diagram illustrating the components of that make up an e-box, representative in a hardware form;

FIG. 3 is a block diagram illustrating the environment in which two AAPs, front ended by e-boxes, may communicate within a trusted environment including the NSE and an outside server;

FIG. 4 is a flowchart illustrating the step-by-step methodology for inter-process communication between two AAPs, their corresponding e-boxes, the NSE, and an outside server;

FIG. 5 is a sequence diagram illustrating an e-boxes initialization phase, and displaying a series of interactions between an e-box and the NSE; and

FIG. 6a-b is a diagram depicting an interruption within the system, whereby an AAP has undergone a change in security level classification while in the midst of receiving a message.

### DETAILED DESCRIPTION

The detailed description set forth below in connection with the appended drawings is intended as a description of the presently preferred embodiment of the invention, and is not intended to represent the only form in which the present invention may be constructed or utilized. The description sets forth the functions and the sequence of steps for developing and operating the invention in connection with the illustrated embodiment. It is to be understood, however, that the same or equivalent functions and sequences may be accomplished by different embodiments that are also intended to be encompassed within the spirit and scope of the invention. It is further understood that the use of relational terms such as first and second, and the like are used solely to distinguish one from another entity without necessarily requiring or implying any actual such relationship or order between such entities.

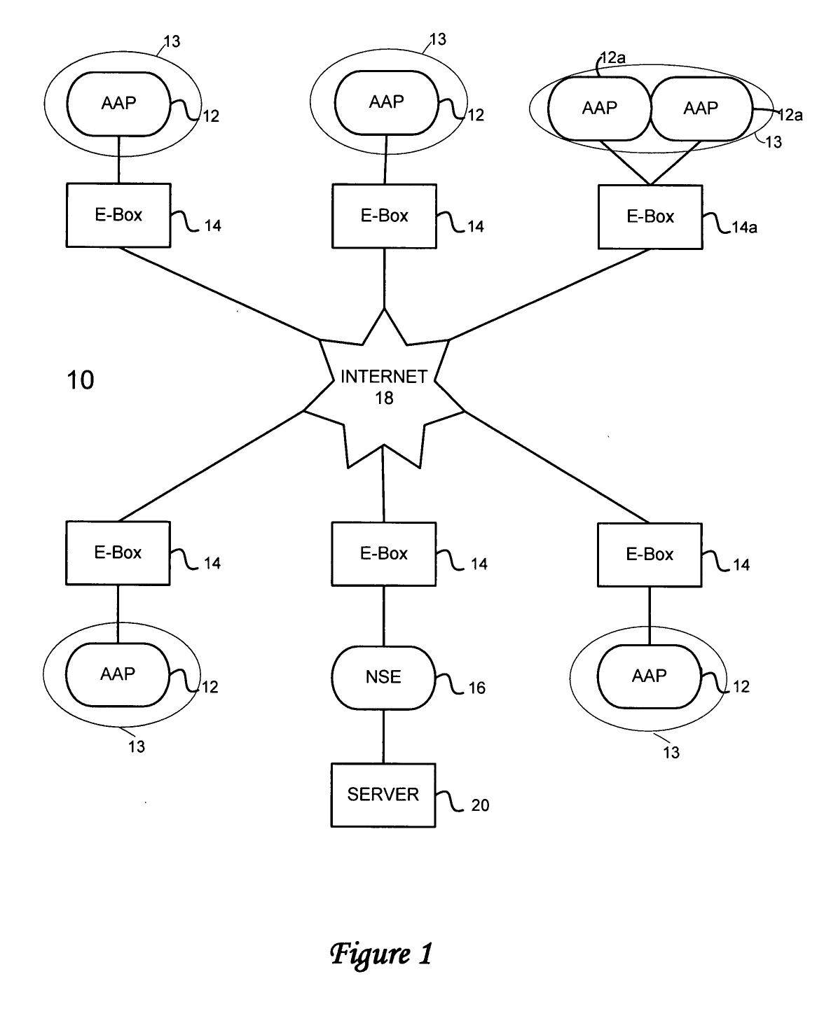

Referring now to the drawing wherein the showing is for purposes of illustrating a preferred embodiment of the invention only, and not for purposes of limiting the same, FIG. 1, shows the general architecture of the security network 10 as conceptualized by an embodiment of the present invention. Although, FIG. 1 shows an exemplary embodiment of the network as targeted towards avionics systems, it should be understood that the network architecture may be tailored to run various functional systems.

Referring to the exemplary embodiment shown in FIG. 1, a network 10 includes various AAPs 12, which are running on processors 13. The processors 13 are front-ended by an e-box 14. The network 10 provides a communication channel for transmitting and receiving messages. Such a communication channel may be the Internet 18. It will be appreciated that the network topology shown in FIG. 1 is presented by way of example only and not of limitation, and any other type of local or wide area network may be readily substituted without departing from the scope of the present invention. It is understood that any well known data transmission protocol may be utilized for the Internet 18.

The architecture of the present system is not limited to a one to one ratio between processes 12 and processors 13. The necessary relationship between the ratio of processes 12 to processors 13 may vary according to design parameters and performance efficiency, among other factors. For example, a particular application may be designed to run multiple processes 12a on one processor 13a. However, that processor 13a is still front ended by an e-box 14a as are other processors 13 upon the network. Such an assignment is predicated upon design requirements and is function specific.

In this regard, an AAP 12 is permitted access to the Internet for a communication channel 18 via an e-box 14. Each AAP 12 has a predisposed security level classification assigned to it by an outside server 20. If an AAP 12 attempts to communicate with another AAP 12, the e-box 14 assesses whether the communication is permissible based on their respective security levels. All communication transmitted or received by an AAP 12 must go through an e-box 14. All communication between an e-box 14 and another e-box 14 is encrypted and authenticated. A preferred embodiment of the present invention may use IPsec, AES-256 encryption and HMAC-SHA-256 integrity hashing protocols.

An e-box 14 receives critical authentication and encryption keys from the NSE 16 based on a security policy set up for the network 10. An outside server 20 may set such policy, which in a military context, may be mission control. All communication between an e-box 14 and the NSE 16 is encrypted and authenticated also. The NSE 16 enforces both Mandatory Access Control (MAC) and Discretionary Access Control (DAC). Therefore, there is a unique key for each element of the security policy. There may be a key for each security level and compartment in the MAC security lattice, as well a representation for each pair within the DAC matrix.

The NSE 16 generates a session key between two AAPs 12 by XORing the relevant policy keys with a one-time random key. Subsequently, the session key is then distributed to each of the AAPs' 12 corresponding e-boxes 14. All connections between two AAPs 12 are simplex. Simplex connections permit a one-way “write up” from a low security level AAP 12 to an equal or higher level AAP 12, thus avoiding the possible security policy violation of a full duplex write-down back channel. Full duplex connections are simulated by two simplex connections, one in each direction for network Read and Write. Advantageously the present invention permits a low level process to send information up to a high level process, but not vice versa.

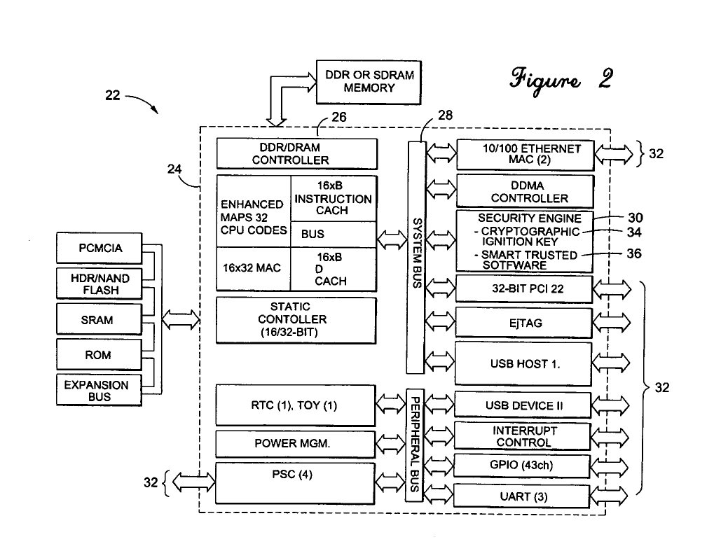

Now, referring to FIG. 2, which illustrates the components making up an e-box, as represented by a hardware device. An e-box 22 may contain an internal central processing unit 24 with local RAM memory 26, a local system bus 28 with memory space, a security engine 30, and I/O ports 32. The security engine 30 holds a cryptographic ignition key 34 and runs smart trusted software 36 that performs the e-box network crypto-connections functions and routing. The software 36 is designed in accordance with Common Criteria EAL 7 to protect classified information. The cryptographic ignition key 34 provides customization of the initialization parameters for the e-box's security level and provides the e-box with the address of the NSE. The security engine 30 provides the ability to encrypt and decrypt messages coming in and out of the e-box 22. However, the conceptual design of an e-box 22 is not limited to only being characterized as hardware. All of the security features provided by an e-box 20 may very likely be represented as software as well.

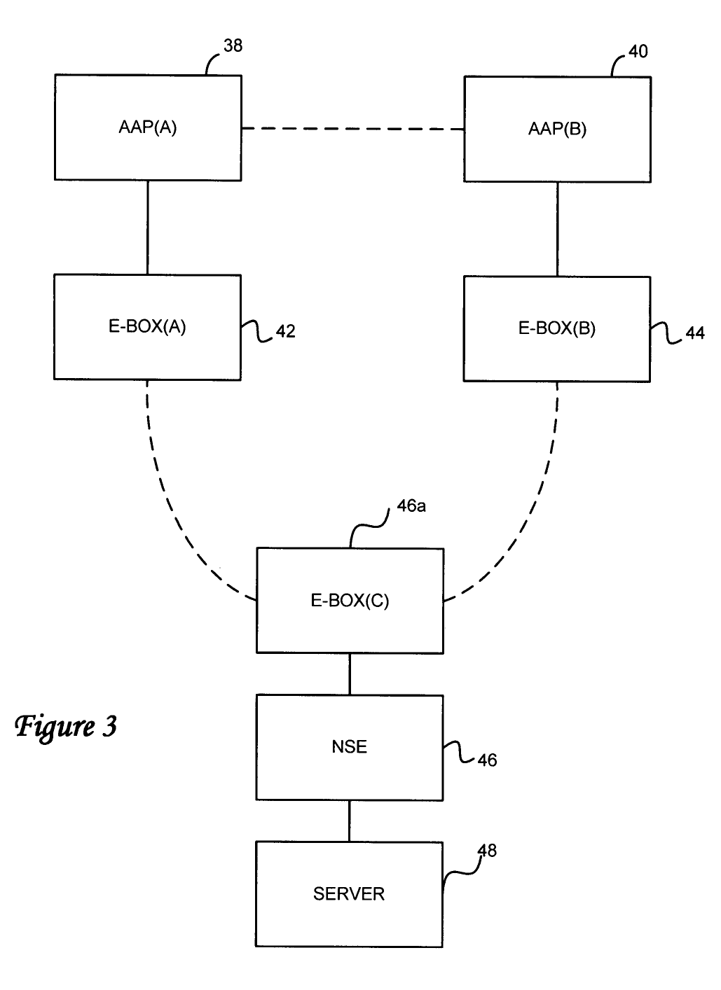

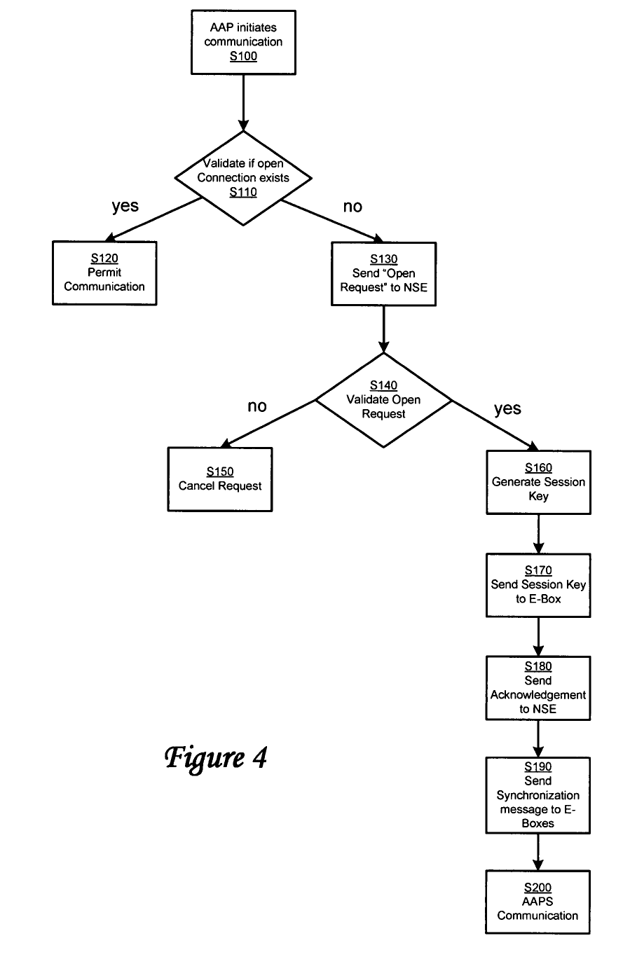

FIG. 3 illustrates the general layout of the present system whereby two AAPs may communicate over trusted inter-process communication. FIG. 4 illustrates the step-by-step method in which the system facilitates communication between AAPs. Now herein referring to FIGS. 3-4, initially, an AAP 38 will initiate communication S100 with another AAP 40. Hereby, AAP(A) 38 will attempt to transmit a message to AAP(B) 40. At this point, S110 the corresponding e-box(A) 42, bound to the initiating AAP(A) 38, will validate the communication request by determining if the AAPs 38, 40 have an “open connection”. An open connection is indicative of whether the two AAPs 38, 40 have previously communicated. If an open connection between AAP(A) 38 and AAP(B) 40 has been established, S120 then AAP(A) 38 will be permitted to send a message to AAP(B) 40.

However, if a connection between the AAPs 38, 40 does not exist S130, e-box(A) 42 will send an “open request” to the NSE 46. All communication between the e-boxes 42, 44 and the NSE 46 is encrypted. Additionally, all communication between e-box(A) 42, e-box(B), and the NSE 46 passes through e-box(C) 46a. Subsequently, S140 the NSE 46 will determine if permission should be granted, allowing the AAPs 38, 40 to communicate. Such permission is based on the security policy as stored within the NSE 46.

If the attempted communication is impermissible S150, the NSE 46 will cancel the communication request. However, if the attempted communication is permissible S160 the NSE 46 will generate a session key and an authentication key with the requisite parameters necessary to allow the AAPs 38, 40 to communicate. A session key is specifically customized for particular communication sessions. Therefore session keys may be generated with precise encryption parameters based upon security level classifications. A session key may be generated via XOR. Additionally, the authentication key may be used to authenticate communication between the two AAPs 38, 40. The session key along with an authentication key is subsequently sent S170 to e-box(A) 42 and e-box(B) 44.

Upon receipt, both e-boxes 42, 44 send an acknowledgement S180 to the NSE 46, confirming receipt of the keys. Thereafter, the NSE 46 generates and sends a synchronization message S190 to both, e-box(A) 42 and e-box(B) 44, instructing them to start using the keys. Thereby, AAP(A) 38 can successfully transmit messages to AAP(B) 40 over a trusted connection protected by the session key S200.

However, AAP(B) 40 is solely capable of receiving messages from AAP(A) 38, and unable to send messages back. Consequently, if AAP(B) 40 wishes to send a message back to AAP(A) 38, e-box(B) 44 must send an open request to the NSE 46, repeating the process S110-S200 in the other direction. The advantageous design of the current system separates each direction request and maintains a separate session key for each request. Thereby, the system may allow a low level AAP to write up information to high level AAP, while at the same time preventing the high level AAP to write down to the low level AAP.

In an exemplary embodiment of the present invention, an e-box 42, 44 may be a hardware component bound to an AAP 38, 40. However, the functionality of an e-box 42, 44 may be embodied in many other forms, including software, whereby it may be loaded and run within the network. Additionally, there may be one NSE 46 regulating thousands of AAP 38 e-box 42 pairs. The NSE 46 may be redundant or distributed for reliability. The NSE 46 has a direct connection to an outside server 48. The outside server 48 may be controlled and accessed under specific conditions, thereby providing the NSE 46 with the essential security policy, by which to regulate the entire network. The boot logic for the system will ideally have the NSE 46 loaded first, followed by prioritized binding assignments for the AAP 38 and e-box 42 pairs loaded from the outside server 48. The security policy of the network as determined by the outside server 48 and will determine the load priorities, locations of all devices and processes (i.e., their net addresses). Additionally, the NSE 46 utilizes public key infrastructure, whereby all communications coming out of the NSE 46 are encrypted in accordance with such public key. All e-boxes 42, 44 have the NSE's 46 public key built within them.

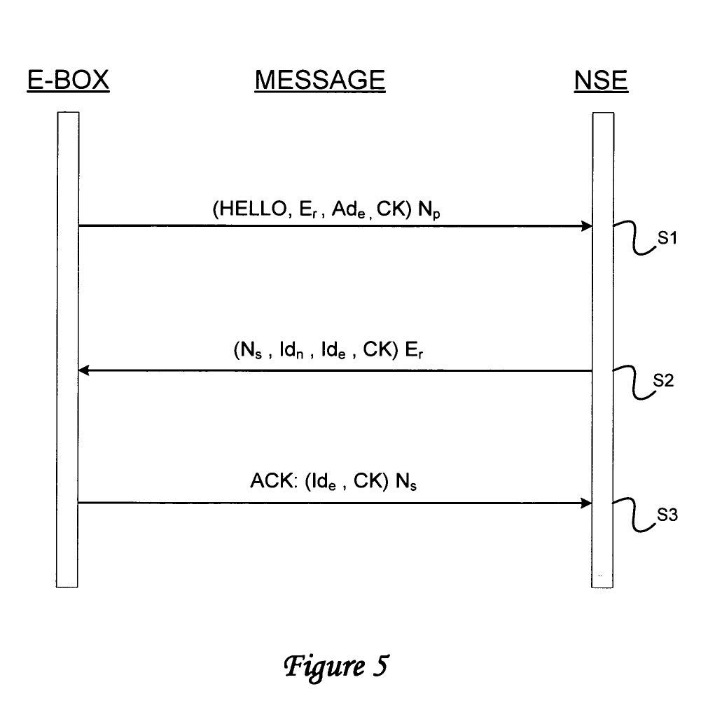

However, static throughout the design of the system is the requisite necessitating that in order for an AAP 38, 40 to be communicative, it must first be bound to an e-box 42, 44. Such a requisite is a supplementary security feature inhibiting any unauthorized transmissions from occurring. An e-box's 42, 44 initial boot requires a series of interactions in order to be validated by the NSE 46. Therefore, a primary requisite for the e-box's 42, 44 initial boot is for the NSE 46 to read the outside server 48 and create loading and/or assigning parameters to bind an e-box 42, 44 to an AAP 38, 40. Upon doing so, an e-box 42, 44 performs a series of exchanges with the NSE 46. FIG. 5 refers to the sequence of interactions between an e-box 42, 44 and the NSE 46 during these initial exchanges.

Now referring to FIGS. 3 and 5. Initially, S1 an e-box 42, 44 generates an initialization message and sends it to the NSE 46. The initialization message comprises of a “HELLO” message, a random key (Eᵣ), the e-box's 42, 44 net address (Adₑ), and an integrity checksum (Ck). The entire initialization message is encrypted by the NSE's 46 public key (Nₚ). Therefore any potential hostile inhabitants that may be on the network or may have access to the network via cyberspace will be unable to ascertain context of the e-box's 42, 44 initialization.

A random key is required because all e-boxes 42, 44 are conceptually identical. Thereby, any e-box 42, 44 may be bound to any AAP 38, 40. Therefore, in order to create a distinctive moniker, by which to characterize an e-box 42, 44, a random key is utilized. The random key may be based on a changing system variable to avoid repeating random keys among different e-box 42, 44 invocations.

Upon verification that such elements are in accordance with the security policy of the system, S2 the NSE 46 saves these parameters and assigns the next priority AAP 38, 40 to this particular e-box 42, 44 by assigning and sending an identity (Idₑ). The NSE 46 subsequently sends a reply message back to the e-box 42, 44 comprising of the identity (Idₑ) of the bound AAP 38, 40, it also includes its own identity (Idₙ), and gives a newly created e-box/NSE session key (Nₛ), and adds an integrity checksum (Ck). The entire reply message is wrapped within the e-box's 42, 44 random key (Eᵣ). The reply message provides critical information securely to the e-box 42, 44, including the session key (Nₛ) for further dialogs with the NSE 46, the identity confirmation of the NSE 46, and an indication that a false NSE 46 is not spoofing it.

Upon receiving the reply message, the e-box 42, 44 generates an acknowledgement message S3. The acknowledgement message comprises of the e-box's 42, 44 identity (Idₑ) and an integrity checksum. The acknowledgement message is wrapped around the NSE-e-box session key (Nₛ) that was previously generated. This final message by the e-box 42, 44 serves as an acknowledgement to synchronize state with the NSE 46.

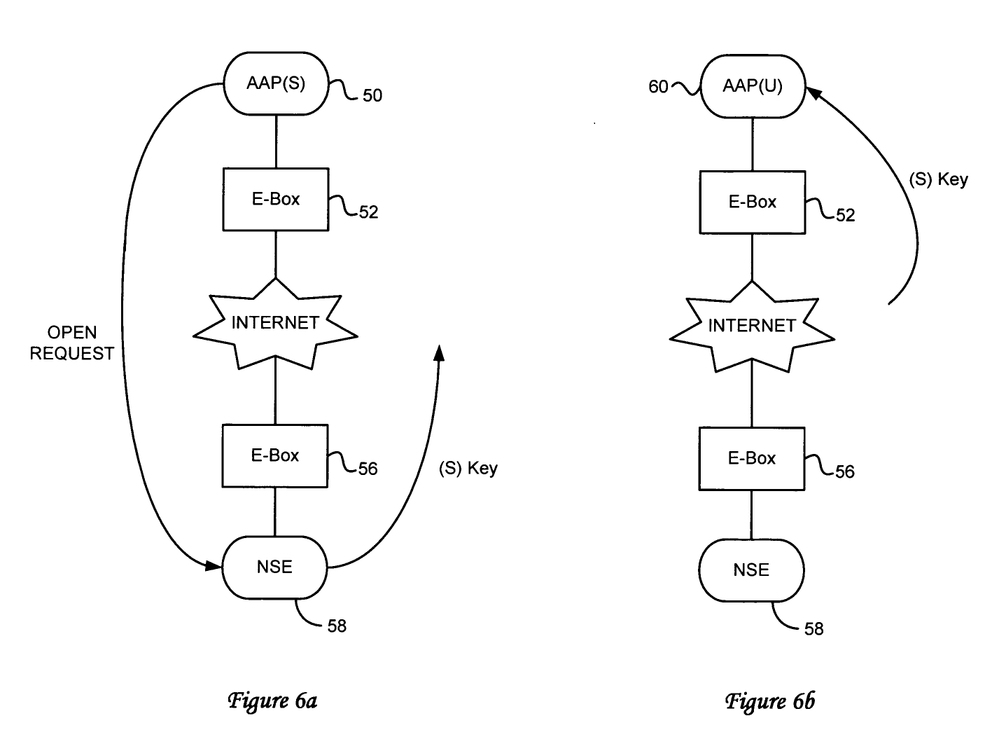

An exemplary embodiment of the present invention may employ security mechanisms ensuring that all communications throughout the network are safeguarded. As a result, it is vital to design and deploy a system capable of being protected against known and unknown hazards. The system must be capable of safeguarding against a known safety issue whereby a process changes classification while in the midst of communication. Thereby, now referring to FIGS. 6a and 6b, where an exemplary embodiment of one aspect of the present system is illustrated indicating the system's adaptation to a changing AAP security level classification. An AAP originally classified as Secret, AAP(S) 50, changes classification levels to Unclassified, AAP(U) 60. A message intended for a AAP(S) 50 should not be received by AAP(U) 60. Such a violation would result in a breach of the network's security policy. It is anticipated that an AAP may change security level classification through intended directive measures or even as a result of unknown error.

Additionally, an exemplary embodiment of the present invention may employ numerous measures to combat sporadic AAP 50, 60 classification changes. Namely, the associated e-box 52 bound to the AAP 50, 60 may simply power down. The advantage of the e-box 52 powering down is that its memory will be flushed, thereby clearing any old session keys. Thus, all connections previously established by AAP 50 will be lost. Such may also be the result if an AAP 50 goes down due to malfunction or power loss. Once the AAP 50 regains its appropriate classification, or regains power, the e-box 52 may simply re-establish its connections. As a result, the e-box 52 shall re-initialize itself. Upon which the NSE 58 will then send a new set of encryption keys for each previously opened connection involving that AAP 50.

The particulars shown herein are by way of example and for the purpose of illustrative discussion of the embodiments of the present invention only and are presented in the cause of providing what is believed to be the most useful and readily understood description of the principles and conceptual aspects of the present invention. In this regard, no attempt is made to show any more detail than is necessary for the fundamental understanding of the present invention, the description taken with the drawings making apparent to those skilled in the art how the several forms of the present invention may be embodied in practice.

What is claimed is:

1) A system for providing trusted inter-process communication on a network with a communication path by securing communication between processes with encryption on the process level, wherein the system comprises:
a plurality of processes transmitting and receiving messages;
a plurality of security devices controlling the communication paths between said processes; and
a network security element coupled to the network, wherein said network security element includes security mechanisms to regulate communication between said processes and security devices.

2) The system of claim 1, where in the network security element is communicable with an outside server.

3) The system of claim 1, wherein the network security element is redundant.

4) The system of claim 1, wherein the network security element is distributed.

5) The system of claim 1, wherein a process is running on the one processor.

6) The system of claim 1, wherein each one of the unique processes is coupled to a one of the unique security device in a one to one relationship.

7) The system of claim 6, wherein said processes transmit or receive messages by passing messages through the security device.

8) The system of claim 1, wherein the network security element stores security levels for said processes, where a high security level is more restrictive than a low security level.

9) The system of claim 8, wherein a process with a high security level does not write to a process with a low security level.

10) The system of claim 8, wherein the network security element assigns binding parameters of said processes and said security devices.

11) The system of claim 1, wherein the network security element communicates with outside servers.

12) A security device for controlling communication between processes on a trusted network, wherein said security device comprises of:
a local bus with memory space;
a network interface connecting said local bus to the trusted network;
a central processing unit with the local RAM;
said central processing unit with local RAM transferring information out of said local bus memory space into said security device local RAM as set forth by a predetermined security policy;
a cryptographic ignition key which provides customization of the initialization parameters for the security device's security level, encryption keys, and PC net addresses; and
said encryption keys are able to encrypt and decrypt messages coming in and out of said security device

13) The security device of claim 12, wherein the security device is split into two functional sides, wherein one side performs functions on sensitive clear text and manages encryption hardware with trusted code, and wherein another side performs functions on untrusted processes that work with the network messaging of cipher text.

14) The security device of claim 12, wherein the security device is a hardware component.

15) The security device of claim 12, wherein the security device is a software component.

16) The security device of claim 14, wherein the security device has a tamper resistant casing.

17) The security device of claim 14, wherein the security device is powered by a router upon the network.

18) A method for initializing a security device in a multi-level secure network, comprising the steps of:
loading parameters into a network security element to bind a security device to a process;
generating a random key and an authentication message within the security device;
sending said random key, authentication message, net address, and integrity checksum from the security device to the network security element;
creating a session key between said security device and the network security element;
assigning a process to the security device, thereby assigning an identity to the security device and process pair; and
sending a synchronization message from the security device to the network security element.

19) The method of claim 18, wherein said step of sending said random key, authentication message, net address, and integrity checksum from the security device to the network security element is wrapped in a public key.

20) The method of claim 18, wherein said step of generating a random key and an authentication message within the security device is a unique random key.

21) A method for processes that are bound to security devices to communicate via a trusted connection in a multi-level secure network, the method comprising the steps of:
initiating a communication link from one process to another process;
validating to see if an open connection exists between said processes;
sending a request to the network security element requesting an open connection,
validating the request within the network security element to determine if connection should be granted between processes,
generating a session key permitting said processes to communicate;
sending the session key to said security devices connected to said processes;
generating an acknowledgement message within the security devices upon receiving the session key and transmitting said acknowledgement message to network security element;
sending a synchronization message from the network security element to the security device of the initiating process; and
instructing the security device to utilize the session key.

22) The method of claim 21, wherein said communication between processes is simplex.

23) The method of claim 21, wherein said step of generating a session key is generated by XORing.

24) The method of claim 21, further comprising the step of providing an authentication key to said security devices, authenticating communication between processes and security devices.
